(19) United States
(12) Patent Application Publication
(10) Pub. No.: US 2009/0189363 A1
(43) Pub. Date: Jul. 30, 2009

(54) Gas Pressure Shock Absorber

(75) Inventor: Michael FRITZ, Breckerfeld (DE)

Correspondence Address: CROWELL & MORING LLP;INTELLECTUAL PROPERTY GROUP, P.O. BOX 14300, WASHINGTON, DC, 20044-4300, US

(73) Assignee: ThyssenKrupp Bilstein Suspension GmbH, Ennepetal (DE)

(21) Appl. No.: 12/360,692

(22) Filed: Jan. 27, 2009

(30) Foreign Application Priority Data
Jan. 29, 2008 (DE) 102008006476.9-21

(51) Int. Cl. B60G 17/04; F16F 9/50

(52) U.S. Cl. 280/124.159; 188/314

(57) ABSTRACT

The invention relates to a gas pressure shock absorber for vehicle chassis having a damper tube (1) and a piston rod (3) which supports a working piston (2) and is disposed in a reciprocally moveable manner in the damper tube (1), wherein a first partial volume (1a) of the inner space of the damper tube (1) can be filled with a damping fluid and a second partial volume (1b) of the inner space of the damper tube (1) can be filled with a gas, and wherein the gas pressure shock absorber has a device for regulating the vehicle level, which is actuated by the introduction of a gas under pressure into the inner space of the damper tube (1). In order to be able to both raise and also lower the vehicle level as often as desired it is proposed that the device for regulating the vehicle level has a separate vessel (4), the inner space of which is divided by a displaceable separating piston (5) into a first partial chamber (6) filled with damping fluid and a second partial chamber (7) which can be filled with gas, wherein the first partial chamber (6) is connected to the first partial volume (1a) of the damper tube (1), and the second partial chamber (7) is attached to a source of compressed gas. The invention also relates to a spring strut with a vehicle support spring made from steel and a gas pressure shock absorber in accordance with the invention.

The invention relates to a gas pressure shock absorber for vehicle chassis in accordance with the preamble of claim 1. The invention also relates to a spring strut for vehicle chassis having a vehicle support spring made from steel and a gas pressure shock absorber.

Gas pressure shock absorbers of this type have been known for a considerable time. It is also known in the case of such gas pressure shock absorbers to provide devices which permit the level of the vibration damper to be adjusted, Thus, for example, a dual-tube vibration damper is known from the document laid open to public inspection DE 30 05 830 A1, which has a level adjustment device. For this purpose provision is made for a valve, which can be actuated from the outside, to be disposed in a flow path between the working chamber of the vibration damper and the piston rod chamber, During installation of the spring struts into the vehicle a level adjustment then needs to be carried out from the outside merely by actuating this valve, In accordance with DE 30 05 830 A1 this level adjustment can basically be effected in two different ways. Either the vibration damper already contains a compressed gas filling prior to being mounted in the vehicle and the required level is regulated, after the damper has been installed into the vehicle, by a reduction in pressure brought about by opening the valve by means of a corresponding mounting rod. Alternatively, the vibration damper as delivered, prior to mounting, does not contain any compressed gas filling and is provided with a corresponding pressure filling during mounting in order to achieve the desired level, for which purpose the valve is actually opened pneumatically by the compressed gas which is to be introduced.

The solution disclosed in DE 30 OS 830 A1 serves to avoid the cumbersome classification, identification and storage of the support springs in the case of spring struts with steel support springs. This cumbersome classification, identification and storage of the support springs is necessary in the prior art, upon which DE 30 05 830 A1 is based, because, for reasons of manufacturing technology, the support springs have relatively large force and construction tolerances which can lead to varying level adjustments. The solution presented in DE 30 05 830 A1 should lead to a situation where it is also possible to use support springs made from steel with very different characteristic values and/or dimensions on one and the same vehicle and/or on one and the same axle of a vehicle and it should still be possible to adjust a uniform vehicle level.

A disadvantage with the solution known from DE 30 05 830 A1 is that with the level adjustment device described therein a level adjustment can be carried out only once, namely upon installation of the spring struts into the vehicle. The known level adjustment arrangement is not suitable for repeated changing of the vehicle level which the vehicle driver brings about as required and which can be repeated as often as desired. Furthermore, in the case of level regulation by introduction of compressed gas into the damper tube in the level regulation device known from DE 30 05 830 A1 it is only possible to change the vehicle level in one direction. By introducing compressed gas via the [lacuna] between the piston rod chamber and a working chamber filled with damping fluid it is only possible to cause the vehicle level to be raised. In contrast, it is not possible to lower the vehicle level.

In practice there are travel situations in which it is necessary to raise the vehicle level as a whole (i.e. on both vehicle axles) or partially (for example, only on the front or only on the rear vehicle axle). An example of such a travel situation is passing over a hump (for example, a so-called “sleeping policeman”) with a vehicle which has a front spoiler. In this case it may be necessary to raise the vehicle level briefly, for example, on the front axle in order to be able to travel over the hump without damaging the spoiler and then to return to the original vehicle level. This may also be necessary in the case of vehicles which are very close to the ground. This necessity applies particularly to sports cars which are produced with the vehicle body very close to the road and which also frequently have a front spoiler. The spring strut known from DE 30 05 830 A1 cannot fulfil the stated requirements for the reasons already stated.

Furthermore, level regulation devices for vehicles are known in which the vehicle support springs are formed as pneumatic springs (cf. for example, DE 103 36 779 A1). From this document a pneumatic height adjustment device for motor vehicles is known in which a cylinder-like or bellows-like pressure body is provided with an outer wall formed from flexible material. The pressure body can be subjected to compressed air via an air connection so that it expands in a preferred expansion direction and in this way the vehicle level is raised. The possible applications of this and all other level regulation devices which cooperate with support springs formed as pneumatic springs are limited to vehicles with pneumatic springs. They cannot be used in the case of spring struts with vehicle support springs made of steel.

It is the object of the invention to provide a gas pressure shock absorber and a spring strut with a vehicle support spring made from steel for vehicle chassis in accordance with the preamble of claim 1 and of claim 4 respectively, in which the vehicle level can be adjusted as often as desired and in both directions, i.e. it should be possible to raise or lower the vehicle level within preset limits whenever a corresponding level adjustment is desired.

This object is achieved by a gas pressure shock absorber having the features of claim 1. Advantageous developments are given in the corresponding subordinate claims. Furthermore, the above-mentioned object is achieved by a spring strut for a vehicle chassis having the features of claim 4.

In the case of the gas pressure shock absorber or spring strut in accordance with the invention the device for regulating the vehicle level has a separate vessel, the inner space of which is divided by a displaceable separating piston into a first partial chamber filled with damping fluid and a second partial chamber which can be filled with gas, wherein the first partial chamber is connected to the first partial volume of the damper tube containing the damping fluid of the shock absorber, and the second partial chamber is attached to a source of compressed gas. Thus with the gas pressure shock absorber in accordance with the invention an effective height adjustment (level regulation) of the vehicle body can be effected on a vehicle with steel support spring suspension in order, for example, to be able to drive over raised areas on the road, and it is then possible to return to the original vehicle level. The vehicle level is raised by introducing compressed gas into the second partial chamber of the separate vessel and then lowered by releasing compressed gas. This can be carried out successively as often as desired. This process is described in more detail hereinunder.

In accordance with the invention an additional separate vessel is disposed on the shock absorber or spring strut, the inner space of which vessel is divided by a displaceable separating piston into two partial chambers. On the one hand the additional vessel is attached with one of the partial chambers via a compressed gas line to a compressed gas chamber so that compressed gas can be introduced into this partial chamber. On the other hand the other partial chamber of the separate vessel, which is filled with damping fluid, is hydraulically connected to the partial volume of the inner space of the damper tube, in which the damping fluid is located.

If compressed gas is introduced into the partial chamber, which can be filled with gas, of the separate vessel, the damping fluid located in the other partial chamber will be forced out of the separate vessel by the displaceable separating piston and into the interior of the damper tube of the gas pressure shock absorber. In this way the volume of the damping fluid inside the damper tube increases and the volume of the gas chamber provided in the gas pressure shock absorber is reduced accordingly. The pressure in the reduced gas chamber is then greater than the pressure which was available in the originally larger gas chamber prior to introduction of compressed gas into the separate vessel. This increase in the pressure in the compressed gas cushion located in the inner space of the damper tube pushes the piston rod out of the inner space of the damper tube and the vehicle level is raised accordingly.

At the same time, in the compressed gas-filled partial chamber of the separate vessel an additional gas cushion is now provided which partially takes over the function of the gas chamber provided in the inner space of the damper tube, i.e. both the gas chamber inside the damper tube and also the gas chamber in the separate vessel serve to compensate for the volume of piston rod which travels into, and out of, the inner space of the shock absorber during piston rod movements.

By releasing the compressed gas from the partial chamber of the separate vessel the vehicle level can be lowered in a controlled manner. If all the compressed gas is released from the separate vessel the separating piston resumes its original starting position in the vessel and the original state inside the gas pressure shock absorber is recreated, i.e. the gas pressure shock absorber then has a gas cushion with the original volume and the original pressure, and the original damping fluid volume is available so that the original vehicle level existing prior to the introduction of compressed gas into the separate vessel is recreated.

In this way the vehicle level can be raised or lowered as often as desired. The limits within which regulation of the vehicle level is possible are fixed by the volume of the separate vessel and by the volume of the inner space of the damper tube.

The level regulation device in accordance with the invention can be used both in shock absorbers which operate according to a single-tube principle of operation and also in those which operate according to a dual-tube principle of operation.

For cost reasons it is possible to use air as the compressed gas but other gasses are also fundamentally suitable for use in the level regulating device in accordance with the invention. When air is used, the source of compressed gas can be formed as a pressure vessel filled with air, which is attached to a compressor driven by the engine of the motor vehicle and is filled with compressed air from this compressor.

The invention is explained in more detail hereinunder with the aid of the drawings in which, in detail,

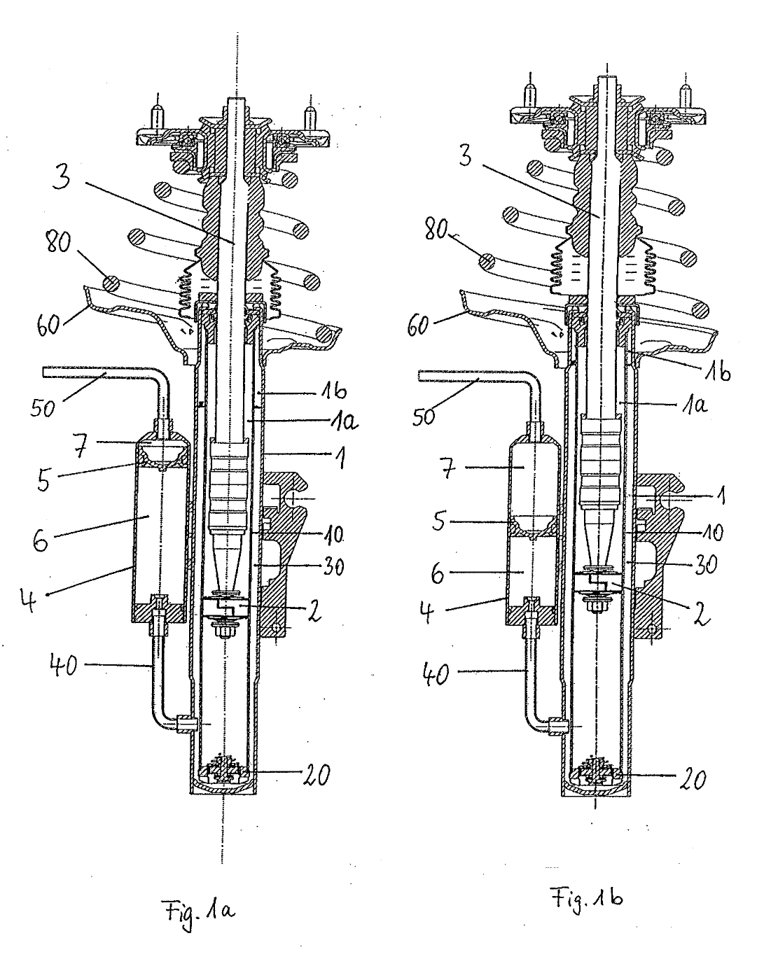

FIG. 1a shows a gas pressure shock absorber according to the dual-tube principle of operation in a first operating position;

FIG. 1b shows the gas pressure shock absorber according to FIG. 1a in a second operating position;

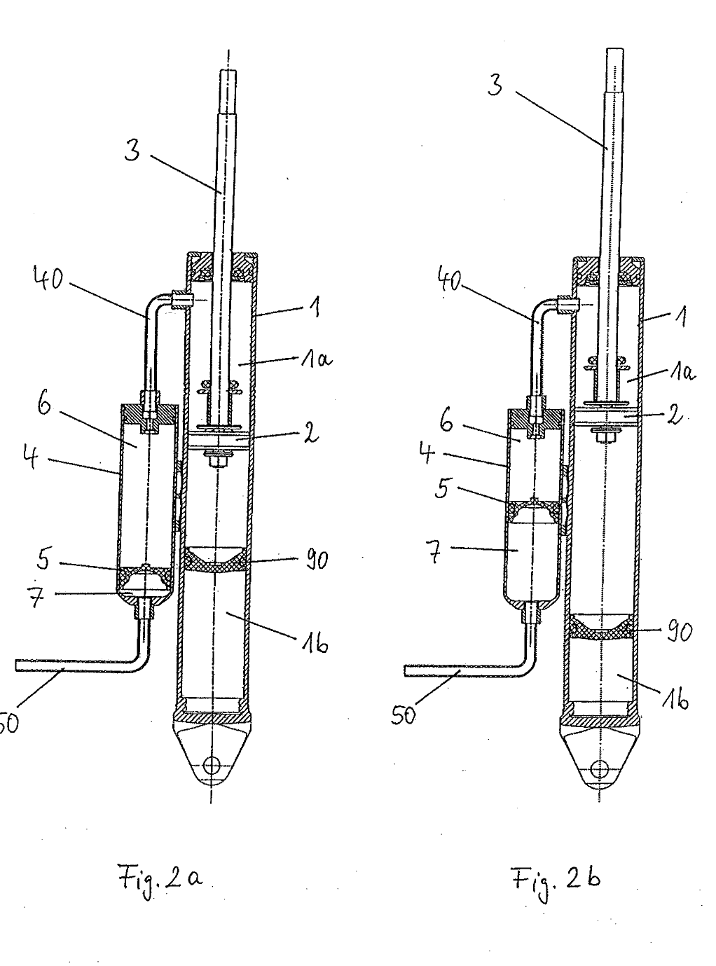

FIG. 2a shows a gas pressure shock absorber according to the single-tube principle of operation in a first operating position;

FIG. 2b shows the gas pressure shock absorber according to FIG. 2a in a second operating position.

In FIG. 1a a gas pressure shock absorber in accordance with the invention is shown which operates according to the dual-tube principle. These shock absorbers are also more concisely known in technical terminology as dual-tube shock absorbers, Inside the damper tube 1 is an inner tube 10 in which the working piston 2 is disposed in a reciprocally moveable manner at the end of a piston rod 3. The inner space of the inner tube 10 is filled with damping fluid. At the lower end of the inner tube 10 a base valve 20 is disposed through which damping fluid can flow into the annular chamber 30 formed between the inner tube 10 and the damper tube 1. The annular chamber 30 serves to receive the damping fluid volume which is displaced by the volume of the piston rod penetrating into the inner space of the inner tube 10. In the annular chamber 30 a gas region (gas cushion) is provided over the region filled with damping fluid and is filled with compressed gas.

Next to the damper tube 1 of the shock absorber a separate vessel 4 is disposed. In the exemplified embodiment illustrated in FIG. 1a the vessel 4 is fixedly connected to the damper tube 1. However, this is not absolutely necessary within the framework of the present invention. The separate vessel 4 could also be attached to another component.

The separate vessel 4 has an inner space which is divided by a displaceable separating piston 5 into a partial chamber 7 which can be filled with compressed gas, and a partial chamber 6 filled with damping fluid. The partial chamber 6 filled with damping fluid is attached by a hydraulic line 40 to the part of the annular chamber 30 in which the damping fluid of the gas pressure shock absorber is located. The partial chamber 7 which can be filled with compressed gas is attached via a compressed gas line 50 to a source of compressed gas, not shown in FIG. 1a. Compressed gas can be introduced into the partial chamber 7 via the compressed gas line 50, whereby the separating piston 5 is displaced within the vessel 4.

The separating piston 5 is sealed in a gas-tight and fluid-tight manner at its periphery with respect to the inner wall of the vessel 4 by a seal formed as a simple O-ring seal.

Displacement of the separating piston 5 within the vessel 4 causes damping fluid to be forced out of the partial chamber 6 by the separating piston 5 and to be introduced via the hydraulic line 40 into the annular chamber 30 formed between the inner tube 10 and the damper tube 1. In this way the damping fluid volume in the annular chamber 30 of the gas pressure shock absorber increases and the volume of the gas cushion in the annular chamber 30 is reduced accordingly, whereby the pressure within the gas cushion increases in turn. By reason of the increased pressure a greater force acts via the substantially incompressible damping fluid on the side of the working piston 2 remote from the piston rod 3 so that the piston rod is pressed further out of the damper tube 1. In this way the vehicle level is raised because the end of the piston rod 3 remote from the working piston 2 is connected to the vehicle body.

FIG. 1b shows an operational position of the gas pressure shock absorber in accordance with the invention in which the separating piston 5 has traveled approximately half of the displacement path available to it within the vessel 4. To the extent that the displacement of the separating piston 5 has caused the volume of the partial chamber 6 receiving the damping fluid to be reduced, the volume of the damping fluid in the annular chamber 30 of the gas pressure shock absorber has increased. FIG. 1b clearly shows that the phase limit between the damping fluid and gas cushion has clearly increased. The volume of the gas cushion is considerably smaller than in the operating position in accordance with FIG. 1a and the pressure within the gas cushion is accordingly clearly higher than in the gas cushion in accordance with FIG. 1a. Thus a greater force is acting on the side of the working piston 2 remote from the piston rod 3, and the piston rod 3 is pushed further out of the inside of the damper tube 1 than in the operating position shown in FIG. 1a. In the operating position shown in FIG. 1b the vehicle body is therefore at a higher level, i.e. is further away from the road surface than in the operating position in accordance with FIG. 1a.

In the described system the function of the shock absorber is fully retained because the partial chamber 7 takes over the function of the gas chamber 1b, which is becoming smaller, in the shock absorber.

In order to lower the level of the vehicle, the compressed gas is released from the partial chamber 7. In order for this to be possible a suitable valve (for example, a 2 port, 3 position directional control valve, also not shown) can be disposed, for example, in the compressed gas line 50 between the compressed gas source, not shown in the figures, and the vessel 4, by means of which valve compressed gas can be released. It may be useful also to provide a sound absorber for the released compressed gas in order to suppress the emission of noise.

FIGS. 1a and 1b show the spring plate 60 which is supported on the damper tube 1 and which for its part supports the vehicle support spring of the spring strut, which is formed as a steel helical spring 80. This piston rod 3 is attached with its end remote from the working piston 2 to the vehicle body in a known manner via a receiver bearing of a spring strut receiver.

FIG. 2a shows a gas pressure shock absorber which operates according to the so-called single-tube principle of operation. Such gas pressure shock absorbers are also known more concisely in technical terminology as single-tube shock absorbers. Like components are designated with the same reference numbers as in FIGS. 1a, 1b. In contrast to FIGS. 1a, 1b, FIGS. 2a, 2b only show the gas pressure shock absorber with the separate vessel 4. In contrast, the spring plate, the vehicle support spring and the attachment of the piston rod to the vehicle body have been omitted.

Inside the damper tube 1 a first partial volume 1a is provided which is filled with damping fluid. Inside the partial volume 1a a part of the piston rod 3 is disposed with the working piston 2 disposed on its end. The working piston 2 can move in a reciprocating manner within the first partial volume 1a which is filled with damping fluid.

Furthermore, the damper tube 1 also encloses a partial volume 1b filled with compressed gas. The partial volume 1b filled with compressed gas is separated from the partial volume 1a filled with damping fluid by a separating piston 90. The gas cushion in the partial volume 1b serves to compensate for the volume of the piston rod entering the damper tube 1 and exiting the damper tube 1 during inwards and outwards movement of the piston rod 3.

Analogously to the exemplified embodiment illustrated in FIGS. 1a and 1b a separate vessel 4 is provided, the inner space of which is divided into two partial chambers 6, 7 by a separating piston 5. A first partial chamber 6 is filled with damping fluid, while a second partial chamber 7 can be filled with compressed gas. Analogously to the exemplified embodiment illustrated in FIGS. 1a and 1b the partial chamber 7 which can be filled with compressed gas is attached to a compressed gas source, not shown in FIGS. 2a and 2b, via a compressed gas line 50. The damping fluid-filled partial chamber 6 of the vessel 4 is attached via the hydraulic line 40 to the partial volume 1a of the damper tube 1 which is filled with damping fluid.

The mode of operation of the level regulating device in accordance with FIGS. 2a and 2b is the same as in the previously described exemplified embodiment in accordance with FIG. 1a and 1b. The difference is that the damping fluid volume forced out of the vessel 4 via the separating piston 5 is not introduced into an annular chamber but directly into the piston rod-side working chamber of the single-tube shock absorber. In this way the volume of the damping fluid in the partial volume 1a of the damper tube 1 increases and the separating piston 90 disposed in the damper tube 1 is displaced downwards so that the gas cushion in the partial volume 1b of the damper tube 1 is reduced. In this way the pressure within the gas cushion increases and an increased pressure acts via the incompressible damping fluid upon the side of the working piston 2 remote from the piston rod 3, whereby the piston rod 3 is pushed further out of the damper tube 1 than in the operating position in accordance with FIG. 2a.

FIG. 2b illustrates an operating position which corresponds to the operating position in accordance with FIG. 1b. The separating piston 5 has traveled approximately half the displacement path available to it within the vessel 4 and the damping fluid still within the partial chamber 6 now corresponds to only about half the damping fluid available in the partial chamber 6 in the operating position in accordance with FIG. 2a. The quantity of damping fluid which is no longer in the vessel 4 in the operating position shown in FIG. 2b is now in the damping fluid-filled partial volume 1a of the damper tube 1, and the gas cushion in the partial volume 1b of the damper tube 1 is clearly smaller than in the operating position shown in FIG. 2a so that the pressure within the gas cushion is clearly higher than in the operating position in accordance with FIG. 2a.

In theory it would also be feasible in the case of a single-tube shock absorber such as that shown in FIGS. 2a and 2b to produce a change in level by introducing compressed gas directly into the gas cushion in the partial volume 1b. However, in practice this has proved not to be the correct procedure since considerable problems were associated therewith because in each case it would be necessary to ensure, when releasing the compressed gas, that the necessary minimum pressure is retained in the damper gas chamber (partial volume 1b) to maintain the damping function. The great advantage of the present invention is, amongst other things, that both in single-tube and also dual-tube shock absorbers, which are filled with compressed gas and damping fluid in the factory, the level regulation upwards and downwards can be effected easily by the introduction of compressed gas without the risk that the properties of the vibration damper set by the factory filling will be changed. In particular, in the case of single-tube shock absorbers it is not possible for the pressure to fall below the necessary minimum pressure of the damper gas chamber.

1. Gas pressure shock absorber for vehicle chassis having a damper tube (1) and a piston rod (3) which supports a working piston (2) and is disposed in a reciprocally moveable manner in the damper tube (1), wherein a first partial volume (1a) of the inner space of the damper tube (1) can be filled with a damping fluid and a second partial volume (1b) of the inner space of the damper tube (1) can be filled with a gas, and wherein the gas pressure shock absorber has a device for regulating the vehicle level, which is actuated by the introduction of a gas under pressure, characterized in that the device for regulating the vehicle level has a separate vessel (4), the inner space of which is divided by a displaceable separating piston (5) into a first partial chamber (6) filled with damping fluid and a second partial chamber (7) which can be filled with gas, wherein the first partial chamber (6) is connected to the first partial volume (1a) of the damper tube (I), and the second partial chamber (7) is attached to a source of compressed gas.

2. Gas pressure shock absorber as claimed in claim 1, characterized in that the separating piston is sealed at its periphery with respect to the inner wall of the vessel (4).

3. Gas pressure shock absorber as claimed in claim 1, characterized in that the vessel (4) is attached to the damper tube (1).

4. Gas pressure shock absorber as claimed in claim 1, characterized in that the device for regulating the vehicle level has means through which compressed gas can be released from the separate vessel (4).

5. Spring strut for a vehicle chassis having a vehicle support spring made from steel and having a gas pressure shock absorber which has a damper tube (1) and a piston rod (3) which supports a working piston (2) and is disposed in a reciprocally moveable manner in the damper tube (1), wherein a first partial volume (1a) of the inner space of the damper tube (1) can be filled with a damping fluid and a second partial volume (1b) of the inner space of the damper tube (1) can be filled with a gas, and wherein the gas pressure shock absorber has a device for regulating the vehicle level, which is actuated by the introduction of a gas under pressure, characterized in that the device for regulating the vehicle level has a separate vessel (4), the inner space of which is divided by a displaceable separating piston (5) into a first partial chamber (6) filled with damping fluid and a second partial chamber (7) which can be filled with gas, wherein the first partial chamber (6) is connected to the first partial volume (1a) of the damper tube (1), and the second partial chamber (7) is attached to a source of compressed gas.

6. Spring strut as claimed in claim 5, characterized in that the separating piston is sealed at its periphery with respect to the inner wall of the vessel (4).

7. Spring strut as claimed in claim 5, characterized in that the vessel (4) is attached to the damper tube (1).

8. Spring strut as claimed in claim 5, characterized in that the device for regulating the vehicle level has means through which compressed gas can be released from the separate vessel (4).

9. Gas pressure shock absorber as claimed in claim 2, characterized in that the vessel (4) is attached to the damper tube (1).

10. Gas pressure shock absorber as claimed in claim 2, characterized in that the device for regulating the vehicle level has means through which compressed gas can be released from the separate vessel (4).

11. Gas pressure shock absorber as claimed in claim 3, characterized in that the device for regulating the vehicle level has means through which compressed gas can be released from the separate vessel (4).

12. Spring strut as claimed in claim 6, characterized in that the vessel (4) is attached to the damper tube (1).

13. Spring strut as claimed in claim 6, characterized in that the device for regulating the vehicle level has means through which compressed gas can be released from the separate vessel (4).

14. Spring strut as claimed in claim 7, characterized in that the device for regulating the vehicle level has means through which compressed gas can be released from the separate vessel (4).
